(19) United States
(12) Patent Application Publication
(10) Pub. No.: US 2024/0185360 A1
(43) Pub. Date: Jun. 6, 2024

(54) HIDDEN REPLY TO OPEN COMMENT IN SOCIAL MEDIA PLATFORMS

(71) Applicant: MALLIKARJUNARAO KODIDALA, HYDERABAD (IN)

(72) Inventor: MALLIKARJUNARAO KODIDALA, HYDERABAD (IN)

(21) Appl. No.: 18/282,577

(22) PCT Filed: Mar. 17, 2022
(86) PCT No.: PCT/IB2022/052451

§ 371 Date: Sep. 18, 2023

(30) Foreign Application Priority Data
Mar. 17, 2023 (IN) 202141011403

(51) Int. Cl. G06Q 50/00

(52) U.S. Cl. CPC G06Q 50/01

(57) ABSTRACT

A computer implemented system configured to operate user-generated features of content on a social media platform wherein the system comprises of a web server to access data like personal details, friends, posts, likes, comments, favourites, followers and following. A database to store all the data containing in the platform. The network interface configured to receive a network communication sent by a generating user of the broadcast comprising an indication that the user-generated features of content has been uploaded. A processor coupled to the network interface and configured to provide options to user to opt open and/or hidden friends, and open and/or hidden comments to be displayed along with the user-generated content to others. The system securely operates the features open or the hidden friends, and the open or the hidden comments.

The present invention generally relates to computer implemented system configured to operate user-generated features of content on a social media platform.

### BACKGROUND OF THE INVENTION

People like to interact with content. Social media provides an easy and convenient way to stay in touch with friends when time doesn't allow you to meet with them in person. We oftentimes share content that we see as benefiting a friend or a group of friends or that has relevance to a relationship. People comment, share, like, retweet or favourite may not represent their true self but their ideal self. People constantly pursue behaviors that bring them closer to their ideal self. Therefore, the content that they share may very well represent the person that they want the world to see and not the person that they truly are.

While social media makes it easier to meet new people and make friends, it also enables cruel people to tear into others with little effort. Perpetrators of bullying can use the anonymity that social networks provide to gain people's trust and then terrorize them in front of their peers. For instance, they might create a fake profile and act friendly to a classmate, then later betray and embarrass them online.

Comment section becomes a platform for insults, threats, arguments, and harassment. The comments or posts posted in social media are available to any individual in public. Unknown people enter bad comments or replies on posts. Sometimes comments are toxic, users may feel mental disturbance. Current social media applications are allowing all people to enter the comments or completely turning off the comments section. There is no restriction to stop unknown people to comment.

Unfortunately, there's no clear-cut way to hide your posts from other people, either hide their comments.

Hence, inventor felt a dire need for a system that can be operated on user-generated features of content on a social media platform, providing options of open and hidden friends, open and hidden comment options to users of the social media platform.

### BRIEF SUMMARY OF THE INVENTION

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Comment sections can devolve into insults, threats, arguments, and harassment. The comments or posts posted in social media are available to any individual. Unknown people enters bad comments or replies on posts. Sometimes comments are toxic, users may feel mental disturbance. Current social media applications are allowing all people to enter the comments or completely turning off the comments section.

Completely turning off the comments section misses good comments, compliments from good people. So we have come up with a new process of comments. Instead of allowing all people to enter the comments, giving commenting access to a set of known audience will solve the problem. Creating two types of comments sections and giving permission to a set of users will solve the problem.

Replies to open comments can be given in open comments section, and replies to hidden comments can be given in hidden comments section. Suppose a person has put a bad comment in open section, a strong reply to that comment will be visible to all, because comment and reply are in open sections.

Here the invention comes into picture. I have introduced a new process called “Hidden reply to open comment”. In this process open comment can be converted into hidden comment and reply will be given to it. So that comment and reply will be displayed only those two people. It's just like one to one discussion.

It is an object of the invention to implement the system and method configured to operate user-generated features of content on a social media platform.

It is another object of the invention to provide options of demarking friends as open and hidden friends, and provide permission to post open and hidden comments to the user-generated content.

According to an aspect of the present invention, a computer implemented system configured to operate along with user-generated content on a social media platform is disclosed.

In accordance with an aspect of the present invention, the system comprises of a web server, a database, a network interface and a processor. The web server to access data like personal details, posts, likes, comments, favorites, followers and following. The database stores all the data containing in the platform.

In accordance with an aspect of the present invention, the said network interface configured to receive a network communication sent by a generating user of the broadcast comprising an indication that the user-generated features of content have been uploaded.

In accordance with an aspect of the present invention, the system comprises rules engine coupled with the network interface and the processor.

In accordance with an aspect of the present invention, the system divides the commenting window into the open comments window and hidden comments window.

Further objects, features, and advantages of the invention will be readily apparent from the following description of the preferred embodiments thereof, taken in conjunction with the accompanying drawings.

### BRIEF DESCRIPTION OF THE DRAWINGS

The invention will be further understood from the following detailed description of a preferred embodiment taken in conjunction with an appended drawing, in which:

FIG. 1 illustrates the images depicting open and hidden comments buttons, according to the exemplary embodiment of the present invention;

FIG. 2 illustrates the images depicting the open comments window, according to the exemplary embodiment of the present invention;

FIG. 3 illustrates the image depicting the hidden comments window, according to the exemplary embodiment of the present invention;

FIG. 4 illustrates the flow chart depicting the hardware involved, according to the exemplary embodiment of the present invention;

FIG. 5 illustrates the image depicting the open and hidden friend's buttons, according to the exemplary embodiment of the present invention.

### DETAILED DESCRIPTION OF THE INVENTION

It is to be understood that the present disclosure is not limited in its application to the details of construction and the arrangement of components set forth in the following description or illustrated in the drawings. The present disclosure is capable of other embodiments and of being practiced or of being carried out in various ways. In addition, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced items. Further, the use of terms “first”, “second”, and “third”, and the like, herein do not denote any order, quantity, or importance, but rather are used to distinguish one element from another.

According to an exemplary embodiment of the present invention, a computer implemented system configured to operate user-generated features of content on a social media platform is disclosed. The system comprises a web server, a database, a network interface and a processor.

The user-generated content comprises one or more of a graphical media object, a text media object, a message board post, a blog post, a member profile, a video media object, an audio media object, a 3D holographic media object, avatars or non-player characters in a video game, a contact, and a service representation. The sharing of content includes a selectable item that when selected, gives an option to define the content for open or hidden comment.

The web server to access data like personal details, friends, posts, likes, favorites followers and following. The database stores all the data containing in the platform. The network interface configured to receive a network communication sent by a generating user of the broadcast comprising an indication that the user-generated features of content have been uploaded.

The said processor coupled to the network interface and configured to provide user with the option of demarking friends as open and/or hidden friends. The open friend list is visible to public and the hidden friends are only visible to the user.

The said system configured to provide the user to give permission to the open and hidden friends to post comments on generated content. The system also divides the comments section into open comments window and hidden comments window.

The said system configured to make open comments to be visible publicly, and hidden comments visible only to the user commented on it and the uploader. The system provides an option to post a hidden comment for an open comment and also to convert open comment into hidden comment by replying it in hidden comment section. It conceals the hidden friend and a hidden comment on the user-generated content. It securely engage open and the hidden friends, and the feature of open and/or the hidden comments.

The system comprises of rules engine coupled with the network interface and the processor, and configured to determine options for using open/hidden friends and comments on the user-generated content. The database records the engaged conversations between the user generating the content and one or more additional users (open/hidden) in open and hidden comment session.

The web server requests authentication from the user before providing the open/hidden comment session, wherein the said requested authentication comprising a log-in session. The notification is displayed with at least one of a new comment, details of the user that posted the new comment, a thumbnail representation of the image associated with the new comment. The notification is only displayed when the user has previously left a comment regarding the same image.

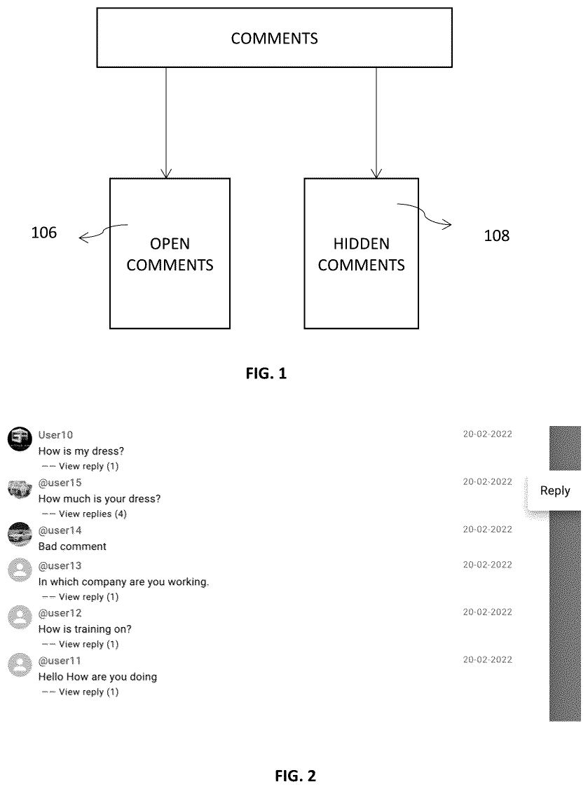

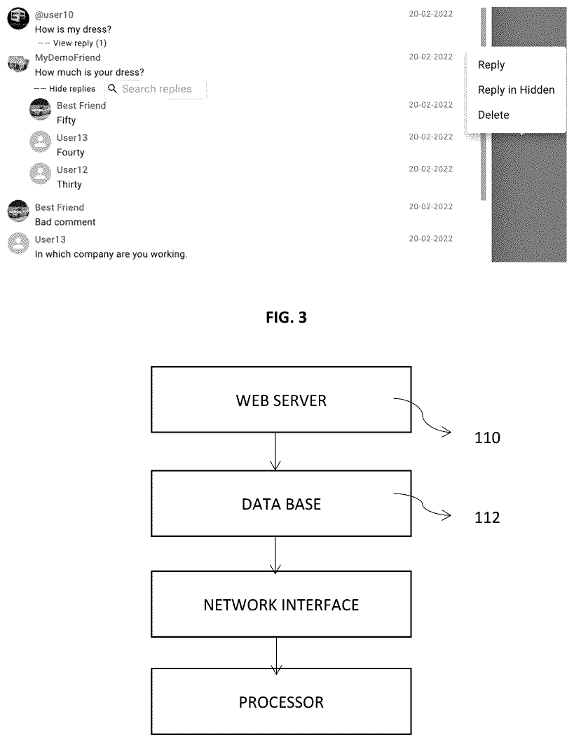

Now referring to the figures, FIG. 1 illustrates the images depicting the open or hidden comments, in accordance with the exemplary embodiment of the present invention. FIG. 2 illustrates the image depicting the open comments by the open friends, in accordance with the exemplary embodiment of the present invention. FIG. 3 illustrates the image depicting the hidden comments by the hidden friends to user generated picture, in accordance with the exemplary embodiment of the present invention.

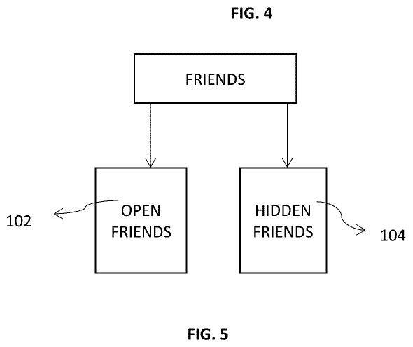

Referring to the figure, FIG. 4 illustrates the flow chart explaining the hardware involved in the system for secure operation of the features open or the hidden friends, and the open or the hidden comments, in accordance with the exemplary embodiment of the present invention.

Referring to the figure, FIG. 5 illustrates the image depicting the friend's list division into the open friends and hidden friends, in accordance with the exemplary embodiment of the present invention.

The processor is further configured to generate metadata indicating a change in one or both of user-generated items of content expected to be included in a broadcast, and the manner in which the user-generated item of content is to be included in the broadcast.

The user-generated content comprises pictures, audio, video and other files categorized and grouped. The user generated content is provided a time prior to an anticipated time at which it is expected to be included in the broadcast.

The system divides the comments into open comment section and hidden comment section. The system issues the options of open friend or hidden friend, and open comment or hidden comment by friends determined by the user generating the content to expose in public or never to expose.

In the existing social media platforms, if two users are following each other they were called friends or followers. In my approach there are two types of friends. Those two types of friends are Open Friends and Hidden Friends.

### Open Friends:

If two users are following each other they are called friends. Some social media applications call them as followers. If another user see these users profile, that user can see that these two are following each other. Every user can see other users followers and following people. This is called open friends. Open friends are visible to all,

### Hidden Friends:

Hidden friends are visible only to the user.

### Creating Comment Section Types

In any social media, anyone can comment on posts or Images on any one's post or profile. If the comments are categorized in to two types and provide permission to set of users (Open friends or Hidden Friends) then the reach of the comment or posts is limited and provide mode privacy. Because user is allowing to comment only a set of users.

### Open Comments

Open comments are the comments which are visible to everyone.

### Hidden Comments

These comments are one to one. User who uploaded the picture can see all hidden comments of all users in a separate window which is not visible to others. While uploading a picture, providing option of enabling Open comments or Hidden comments sections with who can comment on those sections avoids bad and inappropriate comments.

Hidden reply to open comment feature provides privacy in many situations. Users don't have to reply in open section for all open comments. If someone asks a question, and the answer to the question is confidential, answer can be given in hidden section. That reply message will be displayed only to him.

I claim:

1. A computer implemented system, configured to operate user-generated features of content on a social media platform, wherein the system comprises:
a web server to access data like personal details, posts, likes, favorites, followers and following;
a database to store all the data containing in the platform;
a network interface configured to receive a network communication sent by a generating user of the broadcast comprising an indication that the user-generated features of content has been uploaded;
a processor coupled to the network interface and configured to:
open and/or hidden like, and open and/or hidden favorites buttons to be displayed along with the user-generated content to others to choose;
display an open like and an open favorite to others on the user-generated content;
not to display a hidden like and a hidden favorite to others on the user-generated content; and
securely operate the features open or the hidden like, and the open or the hidden favorite.

2. Hidden reply to open comment provides privacy, gallery owner and comments can see the comment and reply.

3. The system as claimed in claim 1, wherein the system comprises a rules engine coupled with the network interface and the processor, and configured to determine rules for using open/hidden like and favorites on the user-generated content.

4. The system as claimed in claim 1, wherein the processor is further configured to generate metadata indicating a change in one or both of user-generated items of content expected to be included in a broadcast, and the manner in which the user-generated item of content is to be included in the broadcast.

5. The system as claimed in claim 1, wherein the user-generated content comprise pictures, audio, video and other files categorized and grouped.

6. The system as claimed in claim 1, wherein the user-generated content is provided at a time prior to an anticipated time at which it is expected to be included in the broadcast.

7. The system as claimed in claim 1, wherein the system divides the gallery into open gallery and hidden gallery, open favorites and hidden favorites.

8. The system as claimed in claim 1, wherein the system issues the options of open like or hidden like, and open favorite or hidden favorite to designated users determined by the user generating the content.

9. A method of operating the features open and/or hidden likes, and favorites on social media platform, wherein the method follows:
accessing the system with login credentials;
providing a like for the posting on the platform involves in selecting the options of open like/hidden like;
providing favorite for the posting on the platform involves in selecting the options of open favorite/hidden favorite; and
providing different galleries for different types of likes and favorites.
